(19) United States
(12) Patent Application Publication
(10) Pub. No.: US 2021/0240769 A1
(43) Pub. Date: Aug. 5, 2021

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventors: Dai TAKESHIMA, Kanagawa (JP); Masato ANDO, Kanagawa (JP); Hirokazu MUKAI, Kanagawa (JP)

(73) Assignee: FUJIFILM Business Innovation Corp., Tokyo (JP)

(21) Appl. No.: 16/932,849

(22) Filed: Jul. 20, 2020

(30) Foreign Application Priority Data
Jan. 30, 2020 (JP) 2020-013307

(51) Int. Cl. G06F 16/906; G06F 16/904; G06F 16/908

(52) U.S. Cl. CPC G06F 16/906; G06Q 30/0627; G06F 16/908; G06F 16/904

(57) ABSTRACT

An information processing apparatus includes a processor. The processer is configured to, in a state where, for a relation diagram that includes plural items having relations and that is generated by systematically connecting the items, plural groups each including at least one of the items are set, and plural sets each including at least one of the groups are set, receive selection of a set from among the plural sets, and in accordance with the selected set, change a display manner of the at least one item included in the at least one group belonging to the set.

### CROSS-REFERENCE TO RELATED APPLICATIONS

This application is based on and claims priority under 35 USC 119 from Japanese Patent Application No. 2020-013307 filed Jan. 30, 2020.

### BACKGROUND

### (i) Technical Field

The present disclosure relates to an information processing apparatus and a non-transitory computer readable medium.

### (ii) Related Art

Japanese Unexamined Patent Application Publication No. 2016-081185 describes a disclosure of an information processing apparatus. The information processing apparatus includes an acceptance unit, a deployment unit, and an output unit. A relation diagram is created by systematically connecting plural function items in accordance with dependence relations of the function items, each of the plural function items representing a function related to quality function deployment. Among the plural function items, a function item representing a function belonging to any of plural processes in the quality function deployment is provided with attribute information for identifying the process to which the function item belongs. Upon the relation diagram being input, the acceptance unit extracts, from the relation diagram, information for identifying the function item, the attribute information provided for the function item, and dependence information for identifying the dependence relations between the function items and accepts them as raw information. The deployment unit classifies the function items according to the process on the basis of the attribute information in the raw information, creates deployment information used for deploying the classified function items for each process, and deploys, on the basis of the deployment information, the raw information into a deployment chart in which the function items are deployed and in which the processes are axes. The output unit outputs the deployment chart deployed by the deployment unit.

### SUMMARY

A group may be set for items indicated in a relation diagram, and plural sets each including at least one group may be set. In such a case, the group set for the items may differ for each set. For example, for an identical item, Group A may be set in a set, and Group B may be set in another set. In a case where the group set for the items differs for each set, if the content of the group set for the items is presented in a visually understandable manner without dividing the relation diagram, convenience for a user who generates the relation diagram is high.

Aspects of non-limiting embodiments of the present disclosure relate to an information processing apparatus and a non-transitory computer readable medium by which, in a case where a group is set for items indicated in a relation diagram, and plural sets each including at least one group are set, the content of the group set for the items is visually presented in accordance with selection of a set.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor. The processer is configured to, in a state where, for a relation diagram that includes plural items having relations and that is generated by systematically connecting the items, plural groups each including at least one of the items are set, and plural sets each including at least one of the groups are set, receive selection of a set from among the plural sets, and in accordance with the selected set, change a display manner of the at least one item included in the at least one group belonging to the set.

### BRIEF DESCRIPTION OF THE DRAWINGS

An exemplary embodiment of the present disclosure will be described in detail based on the following figures, wherein:

FIG. 1 schematically illustrates a configuration of an information processing system according to the exemplary embodiment;

FIG. 2 is a block diagram illustrating a hardware configuration of a server;

FIG. 3 is a block diagram illustrating an example of a functional configuration of the server;

FIG. 4 illustrates a data structure example of a relation diagram information table;

FIG. 5 illustrates a data structure example of an item information table;

FIG. 6 illustrates a data structure example of a relation line information table;

FIG. 7 is a flowchart illustrating a flow of a relation diagram presenting process performed by the server;

FIG. 8 illustrates an example of a user interface provided by the server;

FIG. 9 illustrates an example of the user interface provided by the server;

FIG. 10 illustrates an example of the user interface provided by the server;

FIG. 11 illustrates an example of the user interface provided by the server; and

FIG. 12 illustrates an example of the user interface provided by the server.

### DETAILED DESCRIPTION

Hereinafter, an example of an exemplary embodiment of the present disclosure will be described with reference to the attached drawings. Note that identical or equivalent components and sections are denoted by the same reference numerals in the drawings. In addition, the dimensional ratios in the drawings may be different from the actual ratios by being exaggerated for convenience of description.

First, the background to the exemplary embodiment of the present disclosure that the inventors have arrived at will be described.

Typically, in a system using complex physical phenomena, many events are linked to each other in a chained manner. For example, an effect, such as a final quality of a product, may be caused by plural events, which are caused by plural other events, and the plural other events are caused by plural still other events. In such a complex system, a large number of qualities need to be assured, and cause-and-effect relations between designs and qualities are extremely complex. Accordingly, it is difficult to find a design item that assures a desired quality, and a change in design value for assuring a certain quality may tend to adversely affect the other qualities.

To visualize and organize such complex cause-and-effect relations, relation information is used. The relation information refers to information in which causes and cause-and-effect relations between the causes are defined. An example of a method for representing the relation information is a relation diagram representing logical relations by connecting items representing events serving as effects and items representing events serving as their causes to each other via relation lines. An example of the relation diagram is a logic tree. The relation diagram is suitably used to indicate items representing events serving as effects and items representing events serving as their causes in detail without any missing or overlapping item.

Another example of a method for representing the relation information is a quality function deployment chart representing relations between events listed on plural axes that intersect with each other, by using symbols or numeric values arranged in a matrix. The quality function deployment chart represents relations between events arranged on plural axes in a matrix in which some events are extracted from among many events and arranged on axes. Thus, relations between many events serving as effects and many events serving as causes may be represented simply.

However, if a relation diagram includes too many items representing target events, the diagram becomes excessively complex and large. In addition, the quality function deployment chart is incapable of representing detailed relations including items representing events that are not arranged on axes, and as a result, items tend to be missing.

In a typical, widely used quality function deployment chart, items representing events serving as causes and items representing events serving as effects are arranged on two axes, the horizontal axis and the vertical axis. Thus, it is difficult to represent information about the reasons for the indicated relations. However, it is useful to use a multi-axis quality function deployment chart representing overall relations between events in which three or more axes are arranged to intersect with one another and some events are extracted and illustrated from among the events constituting the relations.

From the above description, by using both a relation diagram and a multi-axis quality function deployment chart, it is possible to extract and illustrate relations between plural events in detail without any missing or overlapping item, while simply displaying the relations between many events. However, it is complicated to convert a relation diagram into a multi-axis quality function deployment chart or to convert a multi-axis quality function deployment chart into a relation diagram, and a system that supports the conversion is necessary.

In a case where a two-axis quality function deployment chart is to be displayed by depicting a relation diagram having hierarchical relations between plural events and selecting a level therefrom, in order to generate a hierarchical relation diagram, the relations between plural events need to be originally organized in a hierarchical manner. Unless the relations between plural events are originally organized in a hierarchical manner, it is difficult to depict hierarchical relations between events in detail without any missing or overlapping item, which is the purpose of the disclosure.

The disclosure disclosed in Japanese Unexamined Patent Application Publication No. 2016-081185 proposes deployment of a quality function deployment chart after selecting an event corresponding to each axis of the quality function deployment chart on a generated relation diagram. In this technique, however, information of the relation diagram is condensed to generate a quality function deployment chart. This decreases information of the quality function deployment chart much less than information of the relation diagram. Thus, although it is possible to generate the quality function deployment chart from the relation diagram, it is difficult in turn to reflect any changes of the quality function deployment chart in the relation diagram.

As described above, the relation diagram and the quality function deployment chart have different roles to visualize the same information defining relations between plural events. Accordingly, it is desired, not only to use either one or to convert either one into the other in one way, but also to generate and view both back and forth while keeping all information of complex relations between events.

Each item in a relation diagram may correspond to each axis of a quality function deployment chart. According to the disclosure disclosed in Japanese Unexamined Patent Application Publication No. 2016-081185, in a relation diagram, a color of an item is set to a color of a corresponding process (an axis in a quality function deployment chart). However, the number of axes set for one item is not limited to one. Even for an identical item, when being deployed in different quality function deployment charts, the item may belong to different axes in the respective quality function deployment charts. Thus, in a case where a color of an item is set to a color of a corresponding axis in a relation diagram, items corresponding to plural axes in deployment charts are present in the relation diagram. Accordingly, in a case where a relation diagram is generated such that plural quality function deployment charts may be generated from one relation diagram, the color set for an item is not sufficient to indicate a correspondence relation between the item and axes. If the relation diagram is divided in order to generate plural quality function deployment charts, it is difficult to overlook the overall relations between items.

Accordingly, this exemplary embodiment will describe a technique by which, in a case where a relation diagram is generated such that plural quality function deployment charts may be generated from one relation diagram, a relation between an item and groups set for the item (e.g., axes of quality function deployment charts) may be visually presented.

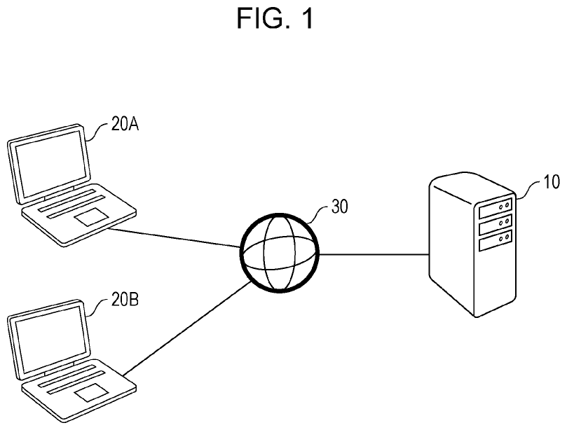

FIG. 1 schematically illustrates a configuration of an information processing system according to the exemplary embodiment. FIG. 1 illustrates a server 10 as an information processing apparatus and user terminals 20A and 20B.

The server 10 is an apparatus that outputs a relation diagram illustrating relations between items representing plural events. The relation diagram represents relations by linking items via lines. The server 10 may represent, as a relation between plural events, a logical relation between events, a relation between an event serving as a cause and an event serving as its effect, a dependence relation between events, or the like. In the exemplary embodiment, the server 10 has functions of receiving input regarding generation of relation diagrams from the user apparatuses 20A and 20B and generating relation diagrams in accordance with the received input. The user terminals 20A and 20B may receive the input regarding generation of different relation diagrams from users.

The exemplary embodiment is applicable to a relation diagram generating process for performing processing to obtain a relation diagram in quality function deployment. For example, in designing a product or a service, a design quality that satisfies customers is set, and in order to embody the set design quality, quality function deployment is applied to checking of relations with the items or components. In quality function deployment, it is necessary to check actual relations properly, and thus, in quality function deployment, many items such as a design quality are set accurately without any missing item (without any omission). In addition, in quality function deployment, one or more processes among a series of related processes are arranged on axes, items of the processes are displayed systematically in a hierarchical manner, and thereby correspondence relations between the items are clarified. The axis is an example of a group in the present disclosure.

The exemplary embodiment is applied to generation of a relation diagram representing correspondence relations (dependence relations) between items in two processes by combining correspondence relations between two related processes (e.g., correspondence relations in a deployment chart in which processes are arranged on axes) for quality function deployment of various cases. The generated relation diagram may be deployed as a two-element chart in quality function deployment. The two-element chart in quality function deployment may be any of various charts, such as a required quality deployment chart, a quality element (characteristics) deployment chart, a planned quality setting chart, a design quality setting chart, a function deployment chart, a mechanism deployment chart, a unit/component deployment chart, a method deployment chart, a new idea deployment chart, and a cost deployment chart. The two-element chart may further be any of various charts, such as a cost plan setting chart, a material deployment chart, a fault tree (FT) deployment chart, a reliability plan setting chart, a measurement equipment deployment chart, a measurement method deployment chart, a business function deployment chart, a technique deployment chart, a quality assurance (QA) chart, a quality control (QC) step chart, and an assured item deployment chart. The relation diagram generated according to the exemplary embodiment may be deployed as any of these charts. Without limitation to the above, the relation diagram generated according to the exemplary embodiment may be used for generating a two-element chart representing correspondence relations between desired processes. In the exemplary embodiment, a relation diagram may be generated such that plural quality function deployment charts may be generated from one relation diagram. Thus, a relation diagram generated in the exemplary embodiment may be generated such that plural quality function deployment charts including at least one axis may be generated. In each of the quality function deployment charts, an axis pattern may differ. The axis pattern is an example of a set in the present disclosure.

Furthermore, the relation diagram generated according to the exemplary embodiment is applied to generation of a diagram for quality function deployment representing correspondence relations between items in each process by combining correspondence relations between, not only two processes, but also three or more (e.g., three or four) processes. Note that in the following description, a diagram for quality function deployment representing correspondence relations between plural processes will be referred to as “multi-element chart”. That is, in the following description, a multi-element chart representing correspondence relations between two processes is referred to as a two-element chart, a multi-element chart representing correspondence relations between three processes is referred to as a three-element chart, and a multi-element chart representing correspondence relations between four processes is referred to as a four-element chart. In addition, in the exemplary embodiment, a process refers to a series of actions that relate to or act on each other for a target event, such as quality-performance-structure-material. Between related processes, an output of a process serves as an input for another (see, for example, JIS Q 9000).

Each of the user terminals 20A and 20B is an apparatus that is connected to the server 10 via a network 30, such as the Internet or an intranet, to receive input regarding generation of a relation diagram from a user. The user terminals 20A and 20B are used by different users. Although FIG. 1 illustrates two user terminals, the number of user terminals is not limited to a particular number in the information processing system. Each user terminal may be any apparatus having a function to be connected to the network 30, such as a personal computer, a smartphone, or a tablet terminal. In the following description, unless it is necessary to distinguish the user terminals 20A and 20B from each other, the user terminals 20A and 20B will be simply referred to as a user terminal 20.

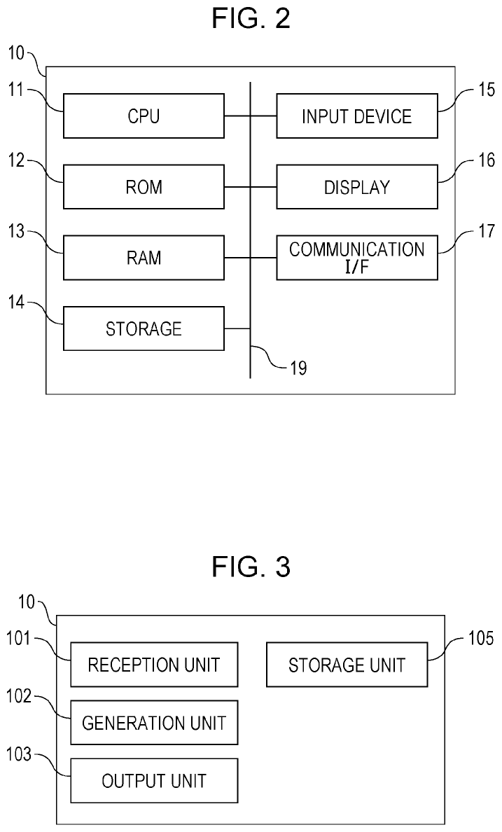

FIG. 2 is a block diagram illustrating a hardware configuration of the server 10.

As illustrated in FIG. 2, the server 10 includes a central processing unit (CPU) 11, a read only memory (ROM) 12, a random access memory (RAM) 13, a storage 14, an input device 15, a display 16, and a communication interface (I/F) 17. The components are connected to each other via a bus 19 to be able to communicate with each other.

The CPU 11 executes various programs or controls each unit. That is, the CPU 11 reads a program from the ROM 12 or the storage 14 and executes the program by using the RAM 13 as a work area. In accordance with the program recorded on the ROM 12 or the storage 14, the CPU 11 controls the above components and performs various arithmetic processes. In the exemplary embodiment, the ROM 12 or the storage 14 stores a relation diagram presenting program for presenting a relation diagram to a user terminal 20.

The ROM 12 stores various programs and various kinds of data. The RAM 13 temporarily stores a program or data as a work area. The storage 14 is constituted by a storage device such as a hard disk drive (HDD), a solid state drive (SSD), or a flash memory, and stores various programs including an operating system and various kinds of data.

The input device 15 includes a pointing device, such as a mouse, and a keyboard and is used by a user to input various kinds of information.

The display 16 is, for example, a liquid crystal display and displays various kinds of information. The display 16 may also function as the input device 15 by employing a touch panel.

The communication interface 17 is an interface for communicating with other equipment such as a user terminal 20, and for example, a standard such as Ethernet (registered trademark), Fiber Distributed Data Interface (FDDI), or Wi-Fi (registered trademark) is used.

When executing the above relation diagram presenting program, the server 10 implements various functions by using the above hardware resources. The functional configuration implemented by the server 10 will be described.

Next, the functional configuration of the server 10 will be described.

FIG. 3 is a block diagram illustrating an example of the functional configuration of the server 10.

As illustrated in FIG. 3, as the functional configuration, the server 10 includes a reception unit 101, a generation unit 102, an output unit 103, and a storage unit 105. Each function is implemented by the CPU 11 reading and executing the relation diagram presenting program stored in the ROM 12 or the storage 14.

The reception unit 101 receives input regarding generation of a relation diagram from a user from a user terminal 20. The input regarding generation of a relation diagram includes various inputs regarding generation of a relation diagram such as setting of items representing events, setting of attribute information for the items, linking between the items, and setting of processes for the items. The server 10 displays a user interface for generating a relation diagram on a screen of a user terminal 20. Information of a relation diagram, items, and relation lines is generated on the user interface of the user terminal 20 by a user operating keys on the keyboard, the mouse, or the like, and the reception unit 101 receives the information. In addition to reception of such information generated by the user operating keys on the keyboard or the like, the reception unit 101 may also, for example, read information stored in a hard disk (including, in addition to one built in a computer, one connected via a network).

In the exemplary embodiment, the reception unit 101 receives, from a user terminal 20, an instruction for switching an axis pattern that is to be set for a relation diagram.

The generation unit 102 generates a relation diagram on the basis of input received by the reception unit 101. The relation diagram is generated on the basis of the information received by the reception unit 101. For example, in accordance with a user editing operation received by the reception unit 101, the generation unit 102 edits items (including addition, deletion, and the like), edits attributes of the items (e.g., item names, characteristics, and the like), rearranges relation lines (including addition, deletion, and the like), and edits attributes of the relation lines (e.g., strength, direction, and the like). In addition, in accordance with a user operation on a screen displayed by the output unit 103, the generation unit 102 displays a new item and another item at different positions separately or at the same position in an integrated manner. The other item has substantially the same attributes as the new item and is already present at a position different from the position of the new item in a relation diagram.

The generation unit 102 generates a relation diagram in a state where items in the relation diagram is colored in a color corresponding to axes set for the respective items. In the exemplary embodiment, axes in plural quality function deployment charts may be set for the items. The generation unit 102 colors the items on the basis of the axis pattern received by the reception unit 101.

The output unit 103 outputs the relation diagram generated by the generation unit 102. The relation diagram is output to the user terminal 20 that has received input regarding generation of a relation diagram from a user. In addition, the output unit 103 stores information about the relation diagram generated by the generation unit 102 in the storage unit 105. In the exemplary embodiment, in accordance with reception of an instruction for switching the axis pattern that is set for the relation diagram, the output unit 103 switches and outputs the relation diagram to be displayed.

The storage unit 105 stores various kinds of information about operations of the server 10. In the exemplary embodiment, the storage unit 105 stores information about a relation diagram. For example, the storage unit 105 stores a relation diagram information table, an item information table, and a relation line information table. Herein, examples of the information about a relation diagram stored in the storage unit 105 will be described.

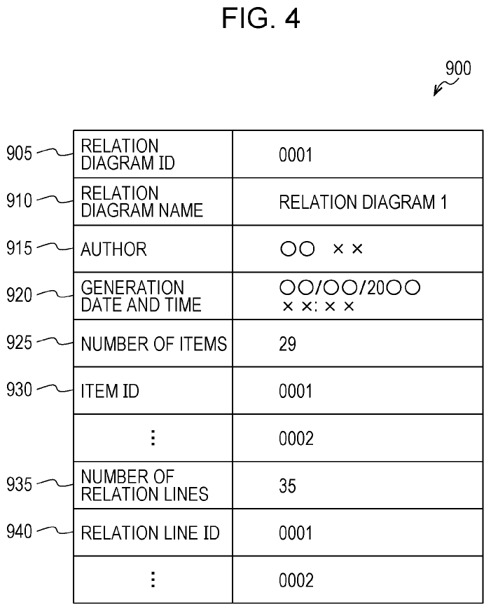

FIG. 4 illustrates a data structure example of a relation diagram information table 900. The relation diagram information table 900 includes a relation diagram identifier (ID) cell 905, a relation diagram name cell 910, an author cell 915, a generation date and time cell 920, a number-of-items cell 925, item ID cells 930, a number-of-relation-lines cell 935, and relation line ID cells 940. In the exemplary embodiment, the relation diagram ID cell 905 stores information (relation diagram ID) for uniquely identifying a relation diagram. The relation diagram name cell 910 stores a name of the relation diagram having the relation diagram ID. The author cell 915 stores an author of the relation diagram. The generation date and time cell 920 stores a date and time at which the relation diagram is generated or edited (year, month, day, hour, minute, second, decimal, or a combination thereof). The number-of-items cell 925 stores the number of items in the relation diagram. There are as many item ID cells 930 as the number of items indicated in the number-of-items cell 925 below the number-of-items cell 925. In the exemplary embodiment, the item ID cells 930 store information (item IDs) for uniquely identifying the items. The information indicated by the item IDs is stored in an item information table 1000. The number-of-relation-lines cell 935 stores the number of relation lines in the relation diagram. There are as many relation line ID cells 940 as the number of relation lines indicated in the number-of-relation-lines cell 935 below the number-of-relation-lines cell 935. In the exemplary embodiment, the relation line ID cells 940 store information (relation line IDs) for uniquely identifying the relation lines. The information indicated by the relation line IDs is stored in a relation line information table 1100.

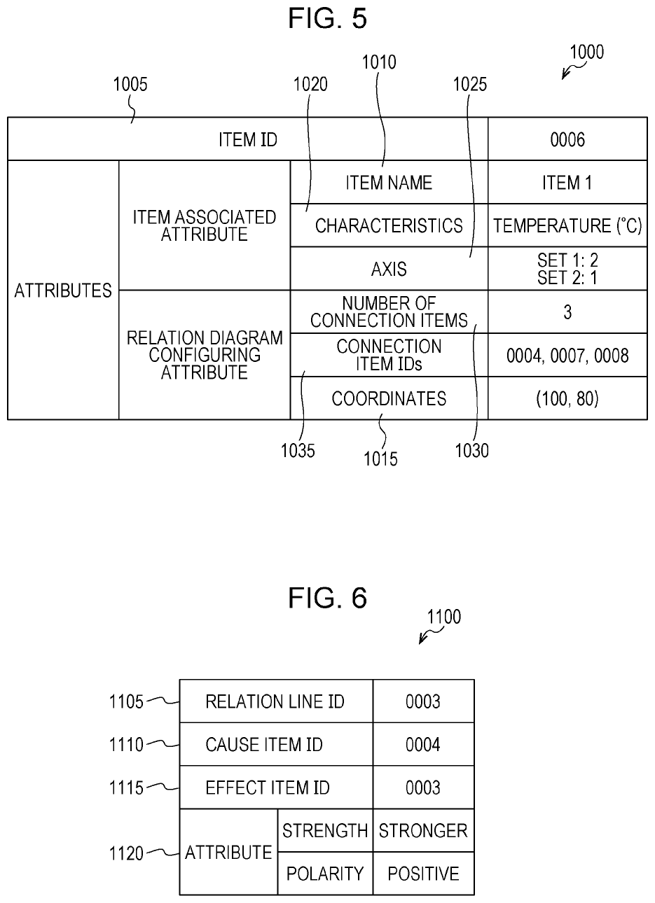

FIG. 5 illustrates a data structure example of the item information table 1000. The item information table 1000 is prepared for each item ID and includes, as attributes, an item associated attribute that is an attribute associated with an item and a relation diagram configuring attribute that is an attribute for configuring a relation diagram. The item associated attribute is attributes such as a name of an item, characteristics, and an axis to which the item belongs. Note that the characteristics herein include a nature, a behavior, and an effect. The relation diagram configuring attribute is attributes such as the number of connection items, connection item IDs, and coordinates. Along with the relation diagram configuring attribute, the item information table 1000 includes an item ID cell 1005, an item name cell 1010, a coordinates cell 1015, a characteristics cell 1020, an axis cell 1025, a number-of-connection-items cell 1030, and a connection item ID cell 1035. The item ID cell 1005 stores an item ID. The item name cell 1010 stores a name of an item having the item ID. The coordinates cell 1015 stores coordinates at which the item is displayed in the relation diagram. The characteristics cell 1020 stores characteristics of the item. The axis cell 1025 stores an axis to which an axis item corresponding to the item belongs when the relation diagram is converted into a deployment chart. In the exemplary embodiment, plural patterns may be set for one item in the axis cell 1025. In the example illustrated in FIG. 5, two patterns are set in the axis cell 1025. The number-of-connection-items cell 1030 stores the number of items to which the subject item is connected. That is, the number-of-connection-items cell 1030 stores the total number of items serving as effects of the item as a cause and items serving as causes of the item as an effect. The connection item ID cell 1035 stores as many connection item IDs as the number of items indicated in the number-of-connection-items cell 1030. The connection item ID cell 1035 stores IDs of items serving as effects and items serving as causes.

FIG. 6 illustrates a data structure example of the relation line information table 1100. The relation line information table 1100 includes a relation line ID cell 1105, a cause item ID cell 1110, an effect item ID cell 1115, and an attribute cell 1120. The relation line ID cell 1105 stores a relation line ID of a relation line. The cause item ID cell 1110 stores an item ID of an item serving as a cause for the relation line. The effect item ID cell 1115 stores an item ID of an item serving as an effect for the relation line. The attribute cell 1120 stores an attribute of the relation line. The attribute is, for example, a polarity of the relation line. The polarity is a nature regarding whether an increase in a numeric value of an item serving as a cause increases a numeric value of an item serving as an effect (e.g., in direct proportion) or whether an increase in a numeric value of an item serving as a cause decreases a numeric value of an item serving as an effect (e.g., in reverse proportion). Also, the attribute is, for example, the strength of a degree of a relation indicated by the relation line as “stronger”, “strong”, “weak”, or “weaker”, or the direction of a relation indicated by the relation line.

Note that the tables illustrated in FIGS. 4 to 6 are examples, and other data structures may alternatively be used. For example, the data structure of a graph may be used.

The generation unit 102 is capable of generating a relation diagram visually representing dependence relations between items by using data stored in the tables illustrated in FIGS. 4 to 6.

In addition, information about a relation diagram is not necessarily stored in the storage unit 105. The information about a relation diagram may be stored in an apparatus other than the server 10.

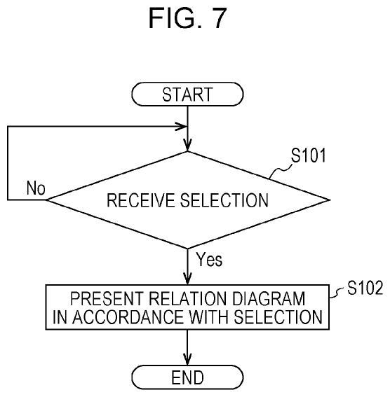

Next, operations of the server 10 will be described. FIG. 7 is a flowchart illustrating a flow of a relation diagram presenting process performed by the server 10. The relation diagram presenting process is performed by the CPU 11 reading a relation diagram presenting program from the ROM 12 or the storage 14 and loading and executing the program in the RAM 13.

The CPU 11 waits until receiving selection of a set from a user on a user interface presented on a user terminal 20 (step S101; No).

Upon reception of selection of the set from the user on the user interface presented on the user terminal 20 (step S101; Yes), the CPU 11 determines the content of a relation diagram to be presented in accordance with the selected set and presents the relation diagram with the determined content to the user terminal 20 (step S102).

Specifically, the CPU 11 presents an item for which an axis included in the selected set is set and an item for which no axis included in the selected set is set in different manners. For example, the CPU 11 presents the item for which an axis included in the selected set is set by using a color in accordance with the axis (other than white) to the user terminal 20. In addition, the CPU 11 presents the item for which no axis included in the selected set is set by using no color or white to the user terminal 20.

The CPU 11 presents the item for which an axis included in the selected set is set and the item for which no axis included in the selected set is set in different manners, thereby visually presenting the content of axes set for the items in accordance with the selection of the set. That is, the CPU 11 may visually present the content of axes set for the items in accordance with the selection of the set without dividing the relation diagram.

Specific examples of a user interface presented by the server 10 to the user terminal 20 will be described.

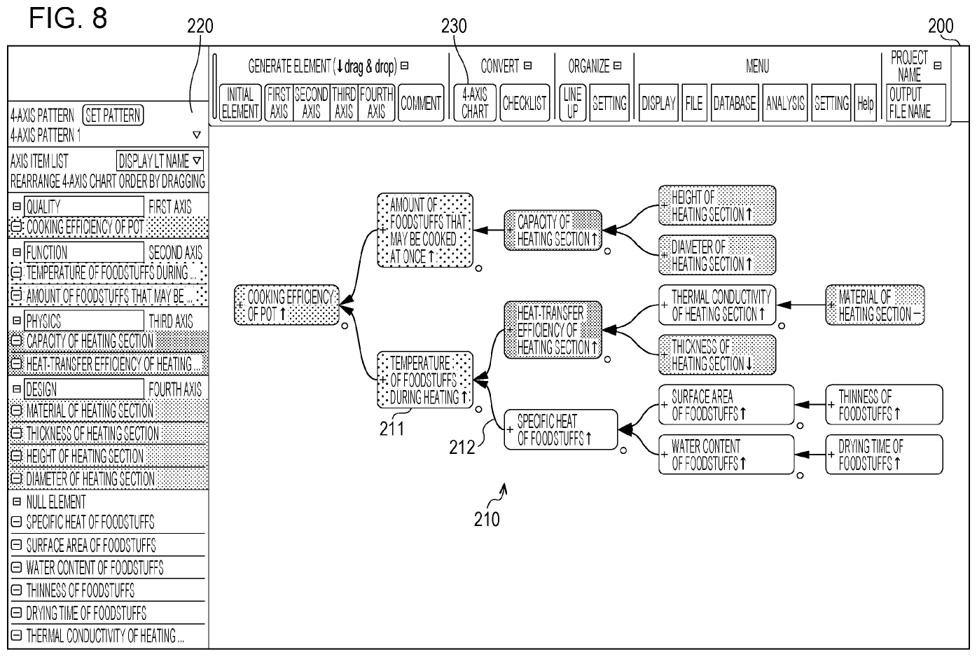

FIG. 8 illustrates an example of the user interface presented by the server 10 to the user terminal 20. A user interface 200 in FIG. 8 is a user interface for presenting a relation diagram 210. The relation diagram 210 is configured by plural items 211 being connected via relation lines 212.

When presenting the relation diagram 210 on the user interface 200, if an axis is set for an item 211, the CPU 11 presents the item 211 by using a color corresponding to the axis. The axis is of a chart that may be generated from the relation diagram 210. In the example in FIG. 8, a first axis “quality” is set for “cooking efficiency of pot”, a second axis “function” is set for “amount of foodstuffs that may be cooked at once” and “temperature of foodstuffs during heating”. In addition, a third axis “physics” is set for “capacity of heating section” and “heat-transfer efficiency of heating section”, and a fourth axis “design” is set for “height of heating section”, “diameter of heating section”, “thickness of heating section”, and “material of heating section”. Thus, the CPU 11 presents, in the relation diagram 210 on the user interface 200, the items for which axes are set by using colors corresponding to the axes and the other items by using no color (or white). The CPU 11 acquires correspondence information between the items and the axes by referring to the axis cell 1025 of the item information table 1000.

The user interface 200 illustrated in FIG. 8 further includes a switching section 220 for switching the axis pattern in the chart that may be generated by being generated from the relation diagram 210. If a user switches the pattern by operating the switching section 220 on the user interface 200, the CPU 11 changes the colors of the items 211 on the basis of the axis pattern after switching.

The user interface 200 illustrated in FIG. 8 further includes a deployment chart generation button 230 for generating a deployment chart from the relation diagram 210. If the user selects the deployment chart generation button 230 on the user interface 200, the CPU 11 generates a deployment chart corresponding to the selected axis pattern. Subsequently, the CPU 11 presents the generated deployment chart to the user terminal 20. Examples of the deployment chart presented by the server 10 to the user terminal 20 will be described later.

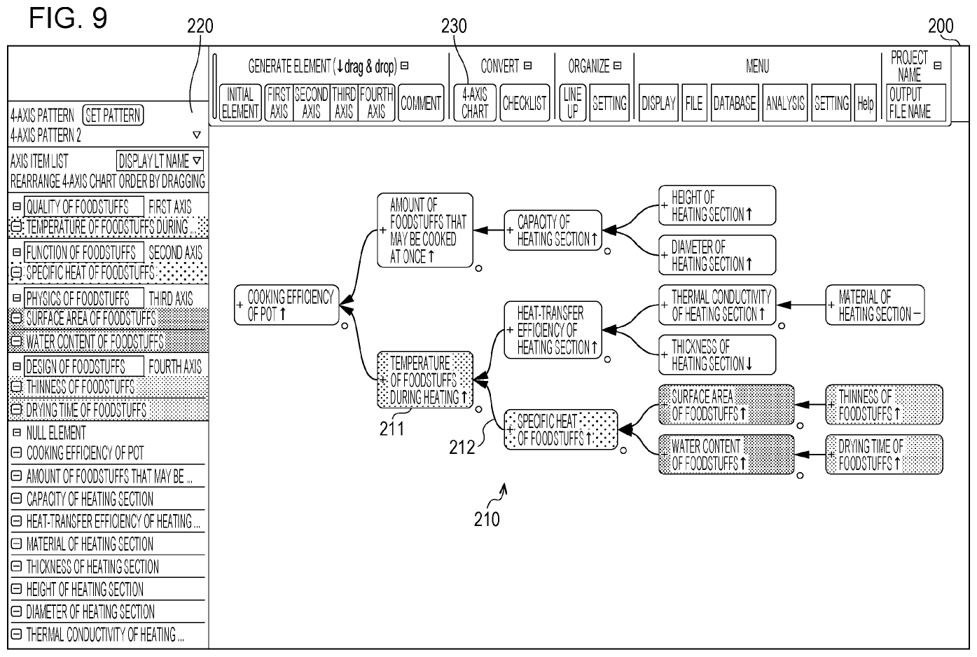

FIG. 9 illustrates an example of the user interface presented by the server 10 to the user terminal 20. The user interface 200 in FIG. 9 is a user interface for presenting the relation diagram 210 as in FIG. 8. FIG. 9 illustrates an example after a user operates the switching section 220 to switch the axis pattern from “four-axis pattern 1” to “four-axis pattern 2”.

In the example in FIG. 9, a first axis “quality of foodstuffs” is set for “temperature of foodstuffs during heating”, and a second axis “function of foodstuffs” is set for “specific heat of foodstuffs”. In addition, a third axis “physics of foodstuffs” is set for “surface area of foodstuffs” and “water content of foodstuffs”, and a fourth axis “design of foodstuffs” is set for “thinness of foodstuffs” and “drying time of foodstuffs”. Thus, the CPU 11 presents, in the relation diagram 210 on the user interface 200, the items for which axes are set by using colors corresponding to the axes, and the other items by using no color (or white).

Now, FIG. 8 and FIG. 9 are compared with each other. The second axis “function” is set for “temperature of foodstuffs during heating” in FIG. 8, whereas the first axis “quality of foodstuffs” is set for the same “temperature of foodstuffs during heating” in FIG. 9.

In this manner, different axes may be set for the identical item depending on the axis pattern. In addition, no axes may be set for some items in an axis pattern, whereas an axis may be set for the items in another axis pattern, as in “surface area of foodstuffs” and “water content of foodstuffs”.

In the above manner, by presenting the items in different manners in accordance with switching of the axis pattern, the CPU 11 may visually present the content of axes set for the items in a relation diagram in accordance with the user's selection of the axis pattern without dividing the relation diagram.

In the exemplary embodiment, the CPU 11 presents the items for which axes included in the selected set are set by using colors. However, the present disclosure is not limited to this example. For example, the CPU 11 may present an item for which an axis included in a selected set by emphasizing the item, for example, by using a thick frame therefor, to be distinguished from an item for which no axis is set.

In addition, in accordance with the switching of the axis pattern, the CPU 11 may present an item for which no axis included in the selected set is set, by using a light color for a line linking items, by using a thin line, or by not displaying a line.

When presenting an item in a relation diagram by using a color in accordance with switching of the axis pattern, the CPU 11 may use a different type of color depending on the axis pattern. That is, the CPU 11 may use a type of color in a state where “four-axis pattern 1” in FIG. 8 is selected and may use a different type of color in a state where “four-axis pattern 2” in FIG. 9 is selected. For example, in a state where “four-axis pattern 1” in FIG. 8 is selected, the CPU 11 may use, for items, green colors that are different in accordance with axes, and in a state where “four-axis pattern 2” in FIG. 9 is selected, the CPU 11 may use, for the items, blue colors that are different in accordance with axes.

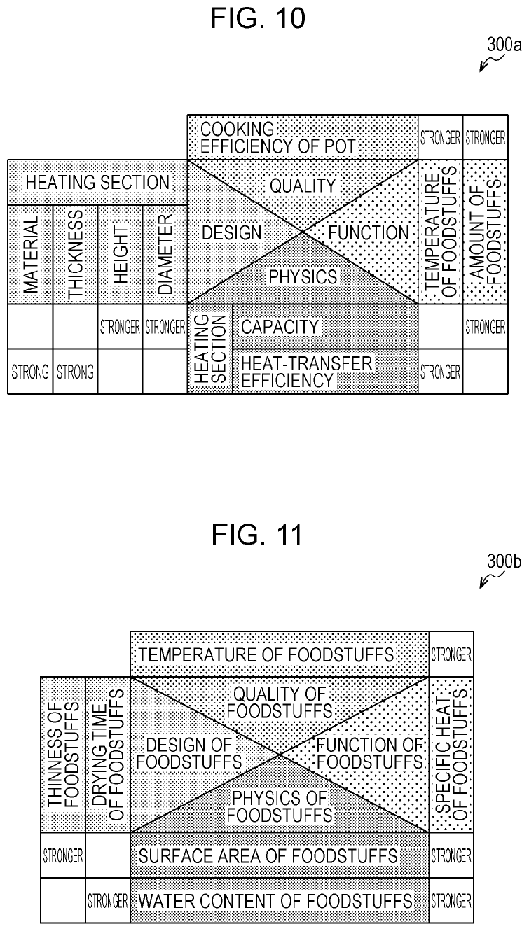

FIG. 10 and FIG. 11 each illustrate an example of the user interface presented by the server 10 to the user terminal 20. FIG. 10 and FIG. 11 illustrate deployment charts generated by the server 10 from the relation diagram 210 illustrated in FIG. 8 and FIG. 9, respectively, by using the disclosure disclosed in Japanese Unexamined Patent Application Publication No. 2016-081185. The deployment charts illustrated in FIG. 10 and FIG. 11 are generated by the CPU 11 by a user selecting the deployment chart generation button 230 illustrated in FIG. 8 and FIG. 9. Since four processes are defined in the relation diagram 210, deployment charts 300a and 300b are each a four-element chart. In FIG. 10 and FIG. 11, for items having correspondence relations, symbols are provided at corresponding positions (cells) in the deployment charts 300a and 300b.

Since the axes “quality”, “function”, “physics”, and “design” are set in FIG. 8, the deployment chart 300a illustrated in FIG. 10 is a four-element chart obtained by deploying the items from the relation diagram 210 to these axes. In addition, since the axes “quality of foodstuffs”, “function of foodstuffs”, “physics of foodstuffs”, and “design of foodstuffs” are set in FIG. 9, the deployment chart 300b illustrated in FIG. 11 is a four-element chart obtained by deploying the items from the relation diagram 210 to these axes.

Comparing FIG. 10 and FIG. 11 with each other, it is found that “temperature of foodstuffs during heating” belongs to different axes in the deployment chart 300a and the deployment chart 300b. In this manner, the server 10 may generate a deployment chart in accordance with the selected axis pattern from one relation diagram without dividing the relation diagram.

As in the relation diagram 210 illustrated in FIG. 8 and FIG. 9, an axis may be set for an item in each of plural axis patterns. In the relation diagram 210 illustrated in FIG. 8 and FIG. 9, an axis is set for the item “temperature of foodstuffs during heating” in each of “four-axis pattern 1” and “four-axis pattern 2”. The CPU 11 may present that an axis is set for an item in each of plural axis patterns.

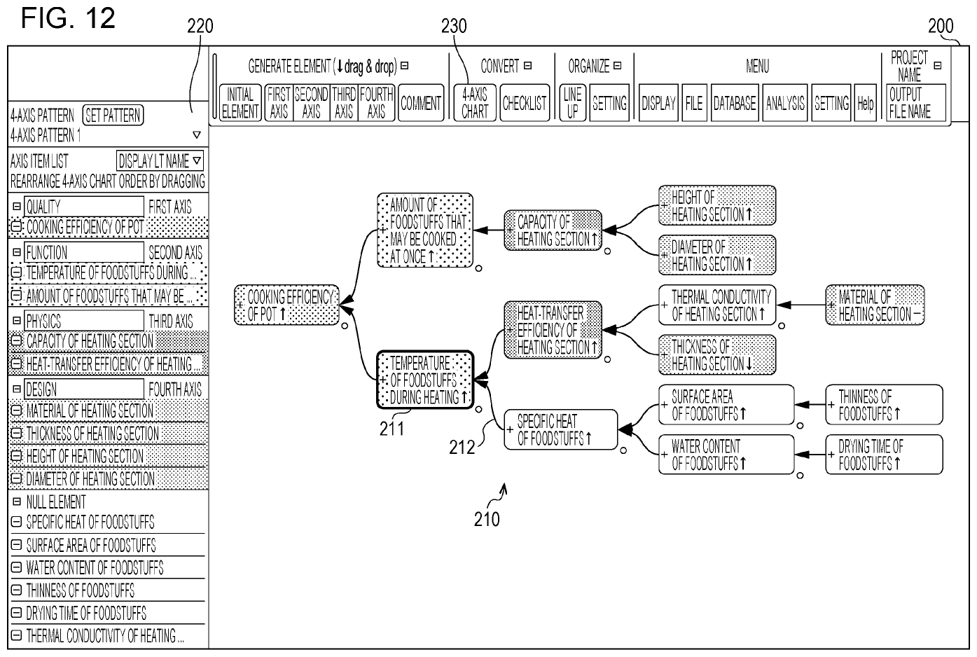

FIG. 12 illustrates an example of the user interface presented by the server 10 to the user terminal 20. Since “temperature of foodstuffs during heating” is an item for which an axis is set in each of “four-axis pattern 1” and “four-axis pattern 2”, the CPU 11 presents “temperature of foodstuffs during heating” by using a thick frame. By presenting an item for which an axis is set in each of plural axis patterns in a manner distinguishable from the other items, the CPU 11 may clarify that an axis is set for the item in each of plural axis patterns. In this case, on the user interface 200, the CPU 11 may present a message indicating that an axis is set for the item in each of plural axis patterns if a user hovers the mouse over “temperature of foodstuffs during heating” or clicks “temperature of foodstuffs during heating”.

Although the exemplary embodiment describes a case where the program for the relation diagram presenting process is stored (installed) in the ROM or the storage in advance. However, the disclosure is not limited to this.

The program may be provided by being stored in a storage medium such as a Compact Disk Read Only Memory (CD-ROM), a Digital Versatile Disk Read Only Memory (DVD-ROM), or a Universal Serial Bus (USB) memory. Alternatively, the program may be downloaded via a network from an external apparatus.

In the embodiment above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment above, and may be changed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to
in a state where, for a relation diagram that includes a plurality of items having relations and that is generated by systematically connecting the items, a plurality of groups each including at least one of the items are set, and a plurality of sets each including at least one of the groups are set,
receive selection of a set from among the plurality of sets, and
in accordance with the selected set, change a display manner of the at least one item included in the at least one group belonging to the set.

2. The information processing apparatus according to claim 1,
wherein the processor presents, among the items, an item included in any of the groups in the selected set and an item not included in the group to be distinguishable from each other.

3. The information processing apparatus according to claim 2,
wherein the processor presents the item included in any of the groups in the selected set by using a color corresponding to each of the groups.

4. The information processing apparatus according to claim 3,
wherein the processor presents the item by using a color a type of which is set for each of the sets.

5. The information processing apparatus according to claim 1,
wherein, if any of the groups in each of the plurality of sets is set for an item among the items, the processor presents that a plurality of groups are set for the item.

6. The information processing apparatus according to claim 5,
wherein the processor presents the item in a manner that a frame of the item is emphasized.

7. The information processing apparatus according to claim 1,
wherein, in accordance with an instruction for generating a deployment chart corresponding to the selected set, the processor generates the deployment chart.

8. The information processing apparatus according to claim 1,
wherein each of the groups is any of two or more axes in a deployment chart that is to be generated from the relation diagram.

9. The information processing apparatus according to claim 2,
wherein each of the groups is any of two or more axes in a deployment chart that is to be generated from the relation diagram.

10. The information processing apparatus according to claim 3,
wherein each of the groups is any of two or more axes in a deployment chart that is to be generated from the relation diagram.

11. The information processing apparatus according to claim 4,
wherein each of the groups is any of two or more axes in a deployment chart that is to be generated from the relation diagram.

12. The information processing apparatus according to claim 5,
wherein each of the groups is any of two or more axes in a deployment chart that is to be generated from the relation diagram.

13. The information processing apparatus according to claim 6,
wherein each of the groups is any of two or more axes in a deployment chart that is to be generated from the relation diagram.

14. The information processing apparatus according to claim 7,
wherein each of the groups is any of two or more axes in a deployment chart that is to be generated from the relation diagram.

15. A non-transitory computer readable medium storing a program causing a computer to execute a process for information processing, the process comprising:
in a state where, for a relation diagram that includes a plurality of items having relations and that is generated by systematically connecting the items, a plurality of groups each including at least one of the items are set, and a plurality of sets each including at least one of the groups are set, receiving selection of a set from among the plurality of sets; and
in accordance with the selected set, changing a display manner of the at least one item included in the at least one group belonging to the set.

16. An information processing apparatus comprising:
processing means for: in a state where, for a relation diagram that includes a plurality of items having relations and that is generated by systematically connecting the items, a plurality of groups each including at least one of the items are set, and a plurality of sets each including at least one of the groups are set, receiving selection of a set from among the plurality of sets; and in accordance with the selected set, changing a display manner of the at least one item included in the at least one group belonging to the set.
